(19) United States
(12) Patent Application Publication
(10) Pub. No.: US 2021/0186661 A1
(43) Pub. Date: Jun. 24, 2021

(54) ORTHODONTIC TRACTION DEVICE

(71) Applicant: ZE FANG LTD., New Taipei City (TW)

(72) Inventor: Yi-Wen Chen, New Taipei City (TW)

(21) Appl. No.: 16/726,814

(22) Filed: Dec. 24, 2019

(51) Int. Cl. A61C 7/22; A61C 7/02

(52) U.S. Cl. CPC A61C 7/22; A61C 7/02

(57) ABSTRACT

The orthodontic traction device includes a base member having an attachment face on a back side, a column member joined to a front side of the base member, and a hook member. The column member includes a knee section whose first end is connected to the front side of the base member, and a linear section connected to and extended from a second end of the knee section. The base member is adhered to a front side of a crooked tooth. As the linear section provides a distance between the hook member and the base member, the force exerted by an elastic element is applied as a torque using the linear section as a lever. The tooth is as such turned toward a desired orientation. An arch wire running through the base member and may pull the tooth to move up or down perpendicularly.

### BACKGROUND OF THE INVENTION

### (a) Technical Field of the Invention

The present invention is generally related to orthodontics, and more particular to a dual-function orthodontic fraction device.

### (b) Description of the Prior Art

Teeth is like a person's façade. A set of crooked teeth usually leads to a bad first impression. Therefore, modern people are quite concerned about how their teeth look.

Dental braces (also known as braces) are commonly used to align and straighten teeth. Usually a flexible arch wire is bended and twisted, and then joined to a number of brackets. The brackets are then attached to a patient's teeth, which, under the pressure of the arch wire, are directed to their desired positions. However, if the crookedness of the teeth is too great to be adjusted through a conventional brace, an elastic band is usually applied and attached to tiny hooks on traditional brackets.

These hooks have a number of shortcomings. For example, they are single-purposed; and they can only work with elastic bands to twist or draw teeth closer laterally. They cannot force teeth to shift upward or downward.

### SUMMARY OF THE INVENTION

A major object of the present invention is to provide a traction device that, through a linear section and a hook member, exerts a rotational force to a tooth, and that, through a channel allowing an arch wire to pass through, exerts a vertical pull on the tooth, thereby achieving a comprehensive orthodontic effect.

To achieve the object, the orthodontic traction device includes a base member having an attachment face on a back side of the base member for attaching to a front side of a tooth, a column member joined to a front side of the base member opposite to the attachment face, and a hook member. The column member includes a knee section whose first end is connected to the front side of the base member, and a linear section connected to and extended from a second end of the knee section. A channel runs through the knee section, and the hook member connected to the linear section.

The base member is attached to a front side of a crooked tooth by applying adhesive between the attachment face and the tooth. Then, an elastic element is run around the hook member. As the linear section provides a distance between the hook member and the base member, the force exerted by the elastic element is applied in the form of a torque using the linear section as a lever. The tooth is as such turned toward a desired orientation. An arch wire may run through the channel. Through a pull by the arch wire, the tooth may be moved up or down perpendicular to the arch wire so as to adjust its vertical position. As such, the present invention they not only can turn crooked teeth, but also can force teeth to shift upward or downward, achieving a comprehensive orthodontic effect.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing a traction device according to a first embodiment of the present invention.

FIG. 2 is another perspective diagram showing the traction device of FIG. 1.

FIG. 3 is a block diagram showing the traction device of FIG. 1.

FIG. 4 is a perspective and enlarged diagram showing how the traction device of FIG. 1 is applied to a tooth.

FIG. 5 is a perspective and enlarged diagram showing how an elastic element is applied to the traction device of FIG. 1.

FIG. 6 is a perspective and enlarged diagram showing how a tooth is adjusted by the traction device of FIG. 1.

FIG. 7 is a perspective showing how an arch wire is applied to the traction device of FIG. 1.

FIG. 8 is a perspective showing how force is exerted by the arch wire of FIG. 8.

FIG. 9 is a perspective diagram showing a traction device according to a second embodiment of the present invention.

FIG. 10 is a perspective and enlarged diagram showing the traction device of FIG. 9 at work.

FIG. 11 is a perspective diagram showing a traction device according to a third embodiment of the present invention.

FIG. 12 is a perspective and enlarged diagram showing the traction device of FIG. 11 at work.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

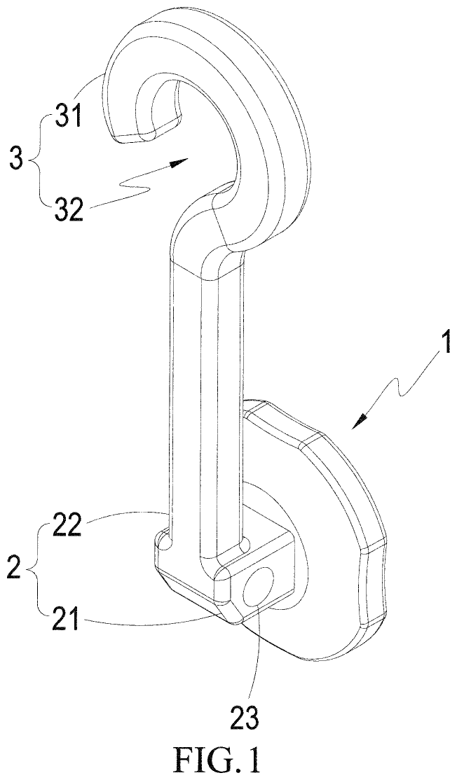

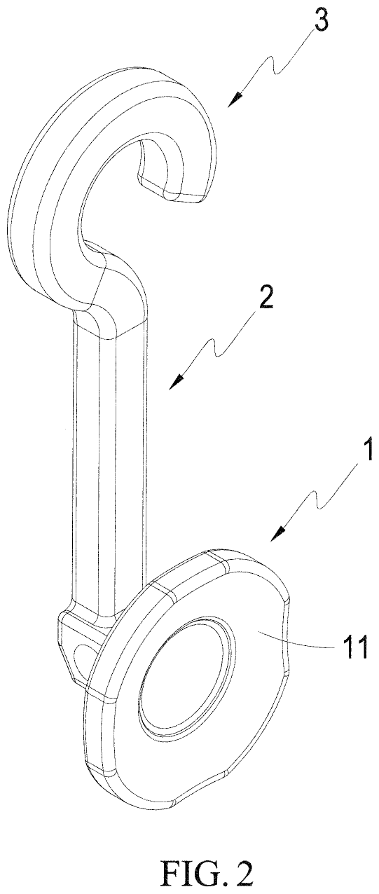

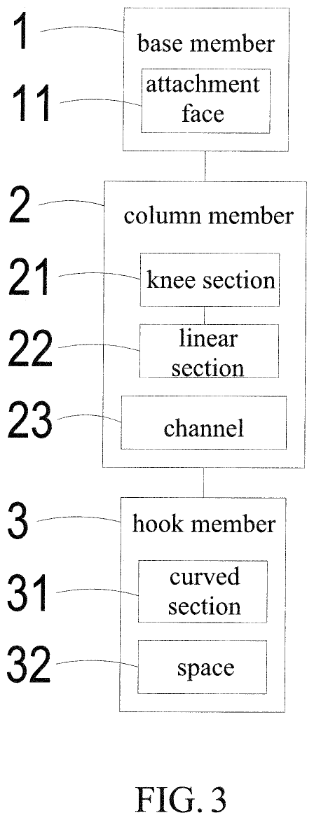

As shown in FIGS. 1 to 3, a traction device according to a first embodiment of the present invention includes the following components.

A base member 1 is made of a ceramic, plastic, or metallic material.

The base member 1 has an attachment face 11 on a back side of the base member 1 for attaching to a front side of a tooth through adhesive.

A column member 2 is joined to a front side of the base member 1 opposite to the attachment face 11. The column member 2 includes a L-shaped knee section 21 whose first end is joined to front side of the base member 1, and a linear section 22 connected to and extended from a second end of the knee section 21. The linear section 22 is therefore parallel to the front side of the base member 1.

A through channel 23 runs through the knee section 21 and is perpendicular to the linear section 22 and parallel to the front side of the base member 1.

A hook member 3 is connected to the linear section 22. The hook member 3 may have different shapes but, in the present embodiment, the hook member 3 includes a C-shaped curved section 31 whose one end is connected to the an end of the linear section 22, and a space 32 surrounded by the curved section 31.

The application of the present embodiment is as follows.

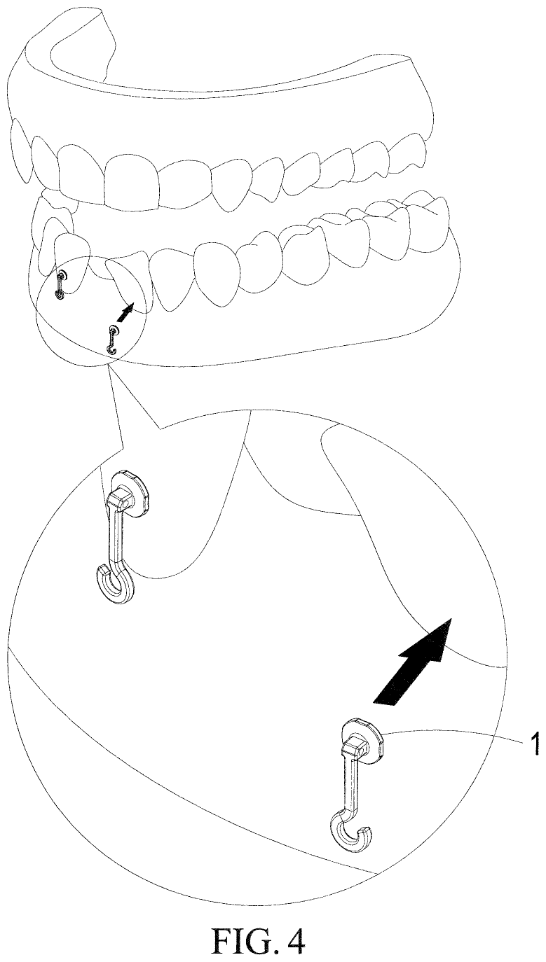

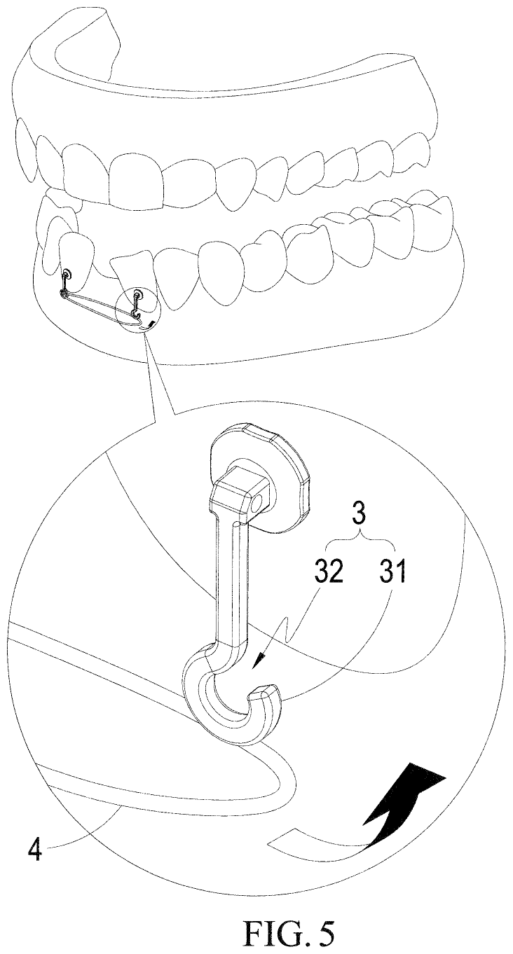

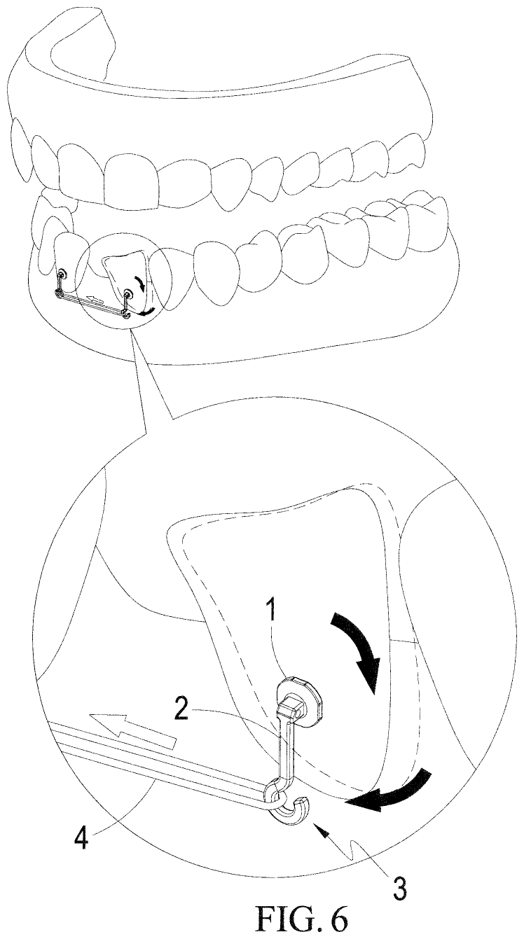

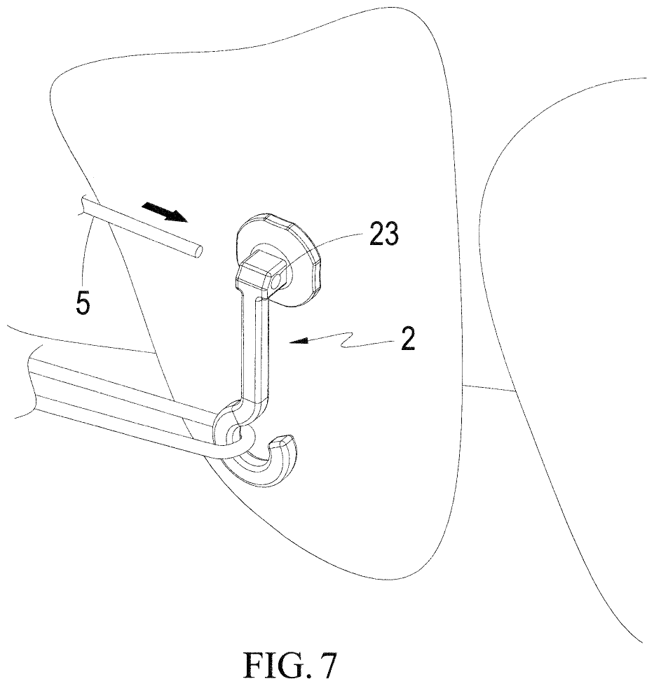

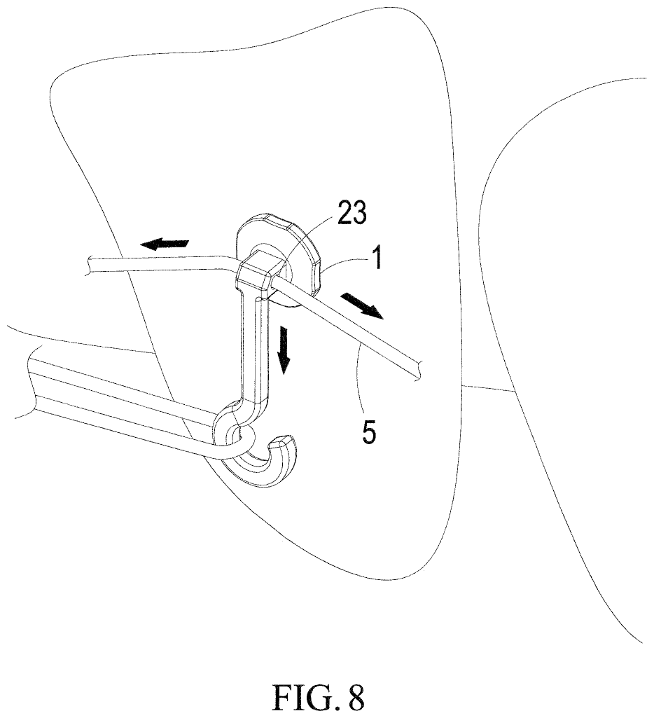

As shown in FIGS. 1 to 8, the base member 1 is attached to a front side of a crooked tooth by applying adhesive between the attachment face 11 and the tooth. Then, an elastic element 4 is run around the curved section 31 of the hook member 3 through the space 32. In the present embodiment, the elastic element 4 is an elastic band. As the linear section 22 provides a distance between the hook member 3 and the base member 1, the force exerted by the elastic element 4 is applied to the tooth through the hook member 3, column member 2, and base member 1 to drive the tooth to a desired location. In addition, the force exerted by the elastic element 4 is applied in the form of a torque using the linear section 22 as a lever. The tooth is as such turned toward a desired orientation.

Furthermore, an arch wire 5 may run through the channel 23 and the arch wire 5 has its two ends tied to brackets, other traction devices, temporary anchorage devices, or other devices. Through the pull by the arch wire 5, the tooth may be moved up or down perpendicular to the arch wire so as to adjust its vertical position. Then, a comprehensive orthodontic effect is achieved from the traction device through its linear section 22, hook member 3, and channel 23.

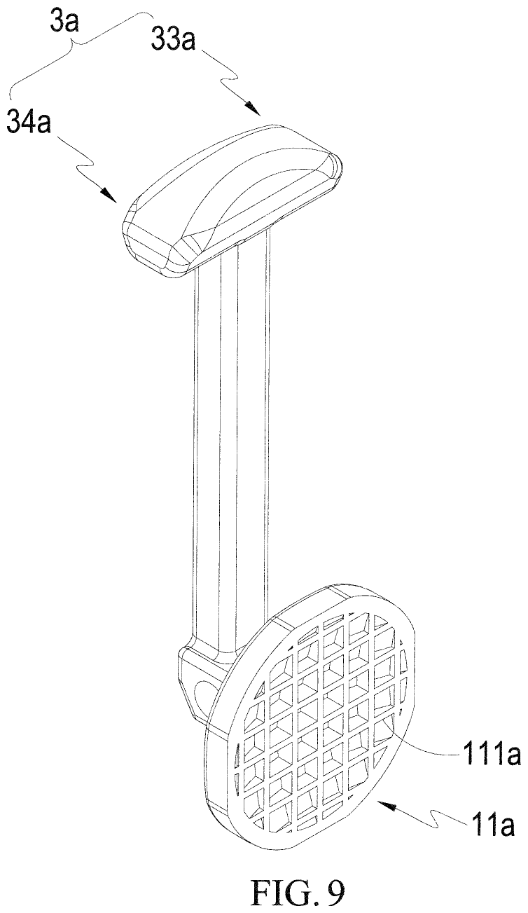

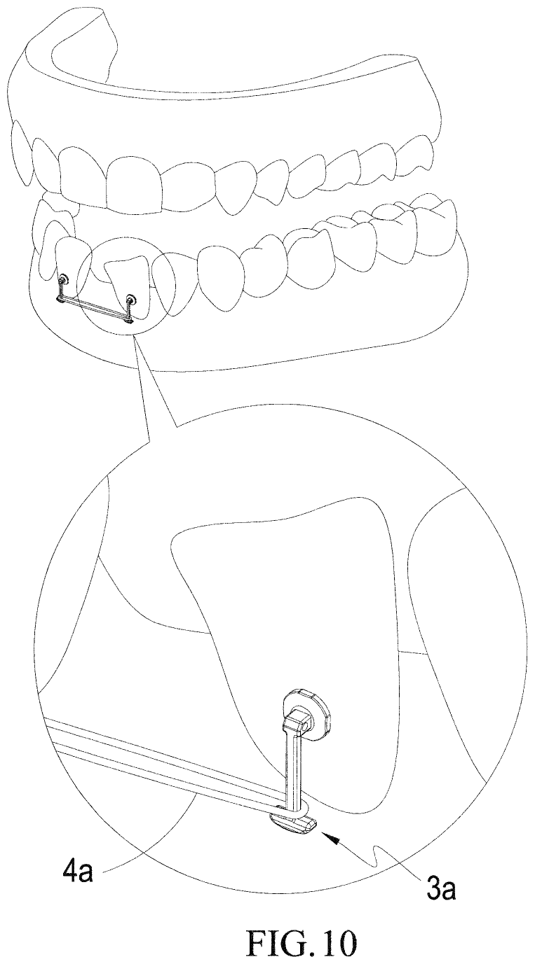

As shown in FIGS. 9 and 10, a second embodiment of the present invention is similar to the previous embodiment, except that a grid 111a is provided along the attachment face 11a for enhancing the attachment face 11a's friction and attachment to the tooth.

Furthermore, in the present embodiment, the hook member 3a now includes a first beam 33a and a second beam 34a, extended toward opposite directions perpendicularly from a top end of the linear section of the column member 2a. As such, the elastic element 4a may be selectively applied to either the first beam 33a or the second beam 34a without turning the hook member 3a. The convenience of the traction device is as such significantly enhanced. The present embodiment also demonstrates that the hook member 3a may be implemented in various ways.

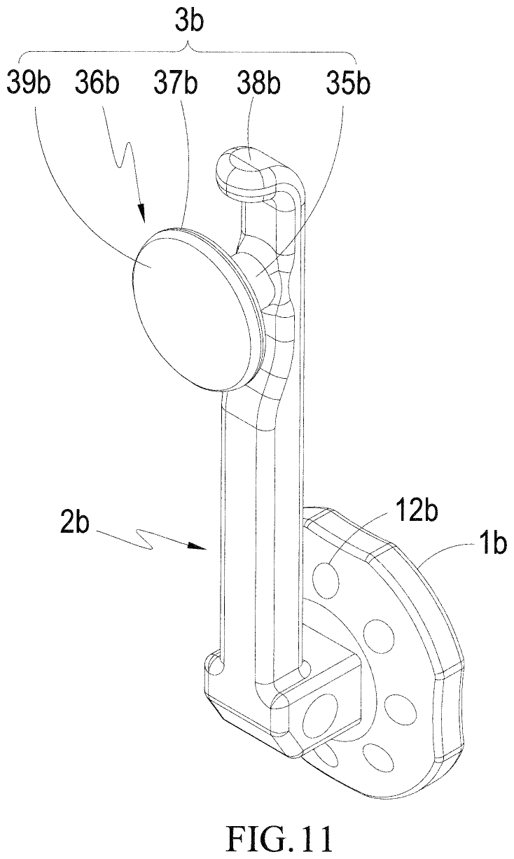

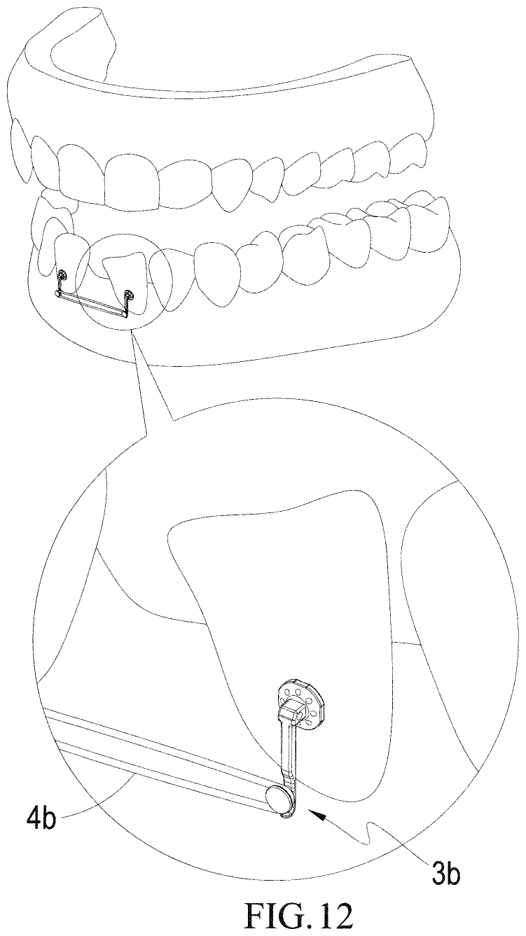

As shown in FIGS. 11 and 12, a third embodiment of the present invention is also similar to the previous embodiments, except that the base member 1b has a number of through holes 12b running from the front side to the back side of the base member 1b so that, when the base member 1b is adhered to the tooth, adhesive may be overflown through the through holes 12b onto the base member 1b, thereby achieving enhanced adhesion.

In addition, the hook member 3b of the present embodiment includes a beam 35b, a stopper 36b, and a limiter 38b. The beam 35b has an end connected to the column member 2b at a preset angle so that the beam 35b is extended from the column member 2b toward a different direction. The stopper 36b is provided on another end of the beam 35b. The stopper 36b has a back side 37b and a front side 39b respectively formed adjacent to the beam 35b and opposite to the beam 35b. The limiter 38b is extended from a top end of the linear section and substantially parallel to the beam 35b. The elastic element 4b is applied by moving over the front side 39b onto the stopper 36b between the back side 37b and beam 35b. The limiter 38b further prevents the elastic element 4b from escape. Therefore, there is no need to adjust the direction of the hook member 3b, and the front side 39b assists the elastic element 4b in looping around the hook member 3b, thereby achieving greater convenience. The present embodiment also demonstrates that the hook member 3b may be implemented in various ways.

Therefore, the gist of the present invention lies in the follows.

The traction device, through the linear section 22 and the hook member 3 to exert a rotational force while the channel 23 allowing an arch wire to exert vertical pull, achieves a comprehensive orthodontic effect.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. An orthodontic traction device, comprising:
a base member having an attachment face on a back side of the base member for attaching to a front side of a tooth;
a column member joined to a front side of the base member opposite to the attachment face, where the column member comprises a knee section whose first end is connected to the front side of the base member and a linear section connected to and extended from a second end of the knee section, and a channel runs through the knee section; and
a hook member connected to the linear section.

2. The orthodontic traction device according to claim 1, wherein the channel provides passage for an arch wire.

3. The orthodontic traction device according to claim 1, wherein the hook member provides anchorage for an elastic element.

4. The orthodontic traction device according to claim 1, wherein the base member has a plurality of through holes running from the front side to the back side of the base member.

5. The orthodontic traction device according to claim 1, wherein the base member has a grid along the attachment face.

6. The orthodontic traction device according to claim 1, wherein the base member 1 is made of a ceramic, plastic, or metallic material.

7. The orthodontic traction device according to claim 1, wherein the hook member comprises a first beam and a second beam respectively extended toward opposite directions perpendicularly from a top end of the linear section.

8. The orthodontic traction device according to claim 1, wherein the hook member comprises a beam and a stopper; the beam has an end connected to the linear section at a preset angle; the stopper is provided on another end of the beam; and the stopper has a back side and a front side respectively formed adjacent to the beam and opposite to the beam.

9. The orthodontic traction device according to claim 8, wherein the hook member further comprises a limiter; and the limiter is extended from a top end of the linear section parallel to the beam.

10. The orthodontic traction device according to claim 1, wherein the hook member comprises a curved section whose one end is connected to an end of the linear section and a space surrounded by the curved section.
